(19) United States
(12) Patent Application Publication
(10) Pub. No.: US 2023/0036192 A1
(43) Pub. Date: Feb. 2, 2023

(54) LIVE AUDIO ADVERTISING BIDDING AND MODERATION SYSTEM

(71) Applicant: nedl.com, Inc., Santa Monica, CA (US)

(72) Inventor: Ayinde Alakoye, Santa Monica, CA (US)

(21) Appl. No.: 17/811,746

(22) Filed: Jul. 11, 2022

Related U.S. Application Data
(60) Provisional application No. 63/225,997, filed on Jul. 27, 2021.

(51) Int. Cl. H04H 60/58; G06F 3/16; H04H 20/74; G10L 15/26; G06Q 30/02

(52) U.S. Cl. CPC H04H 60/58; G06F 3/165; H04H 20/74; G10L 15/26; G06Q 30/0275

(57) ABSTRACT

Systems and methods for providing real-time searching of audio streams to facilitate content moderation and advertising offer generation are provided. The method includes receiving a plurality of audio streams, converting each of the audio streams, in real-time, into one or more text segments, saving each text segment to a data store of real-time content, receiving one or more advertiser bids, wherein each of the one or more advertiser bids includes one or more bid criteria, determining whether the one or more bid criteria are met for an audio stream of the plurality of audio streams, selecting one or more winning bids from advertiser bids in which the one or more bid criteria have been met, generating one or more advertising offers for each of the one or more winning bids, and presenting the one or more advertising offers to a representative of the audio stream.

### CROSS-REFERENCE TO RELATED APPLICATION(S)

This application claims priority under 35 U.S.C. § 119(e) to U.S. Provisional Application No. 63/225,997, filed Jul. 27, 2021, the disclosure of which is incorporated herein by reference in its entirety.

### TECHNICAL FIELD

Embodiments of the present disclosure relate to live broadcast transcription and, in particular, to identifying and transcribing spoken words within live broadcasts to facilitate advertisement generation and content moderation.

### BACKGROUND

Digital audio streaming has become one of the most popular ways for audiences to consume audio content in the modern world. Almost every over-the-air live broadcaster has an Internet feed or software application by which consumers all over the world can listen to the broadcast station via the Internet. In addition, the rise of streaming has spawned countless Internet-only broadcasters who do not have over-the-air transmissions but who make their broadcasts available only via a digital stream. Even conventional broadcasting services, such as satellite radio, have added “digital-only” channels that stream audio of a variety of genres all over the nation and the world.

Broadcasting services typically give a user the option to choose from a wide variety of broadcasting stations. Based on this wide variety of broadcasting stations, it can be time consuming for a user to browse through the broadcasting stations in an attempt to find a specific topic being discussed, or a song or an artist that is being played at that present time. Additionally, it is currently difficult for a user to search the wide universe of broadcasting stations for a specific topic, artist or song, and it is currently difficult for advertisers to search for content, in real-time, to enable pointed, content-specific advertisements during, and based on, live broadcasts.

In addition, due to the dynamic nature of live broadcasting, it is currently difficult to facilitate real-time content moderation and provide content-driven real-time ratings for live broadcasts.

This document describes a real-time live digital audio stream searching and presentation system that is directed to solving the issues described above, and/or other issues.

### SUMMARY

According to an aspect of the present disclosure, a method of providing real-time searching of audio streams to facilitate content moderation and advertising offer generation is provided. The method includes receiving, using a digital media search and presentation service, a plurality of audio streams from a plurality of audio content sources, converting, using the digital media search and presentation service, each of the audio streams, in real-time, as the audio streams are received, into one or more text segments, wherein each text segment of the one or more text segments corresponds to a snippet of its corresponding audio stream and includes words spoken or sung in the snippet, saving each text segment to a data store of real-time content, receiving, using a programmatic graphical user interface of a real-time bidding system, one or more advertiser bids, wherein each of the one or more advertiser bids includes one or more bid criteria, and determining, using a processor, for at least one of the one or more advertiser bids, whether the one or more bid criteria are met for an audio stream of the plurality of audio streams. The method further includes, when the one or more bid criteria have been met for the at least one of the one or more advertiser bids, selecting, using the processor, one or more winning bids from advertiser bids in which the one or more bid criteria have been met, generating, using the processor, one or more advertising offers for each of the one or more winning bids, and presenting, using the processor, the one or more advertising offers to a representative of the audio stream.

According to various embodiments, the converting each of the audio streams comprises receiving the audio stream, processing the snippet of the audio stream with a speech-to-text converter, and saving output from the speech-to-text converter as the text segment.

According to various embodiments, receiving the plurality of audio streams from a plurality of audio content sources comprises receiving one or more audio streams from a digital streaming source via a communication network, and receiving one or more audio streams from an over-the-air broadcasting source.

According to various embodiments, the one or more bid criteria includes an utterance one or more phrases within the audio stream, and each of the one or more phrases includes one or more predetermined words or sounds.

According to various embodiments, the method further comprises using a real-time moderation system including a processor, determining and assigning, to each audio stream, at least one of: a rating; and a classification.

According to various embodiments, the bid criteria includes a presence or absence of one or more of: one or more ratings of the audio stream; and one or more classifications of the audio stream.

According to various embodiments, the method further comprises performing, using the real-time moderation system, one or more moderation tasks.

According to various embodiments, the one or more moderation tasks include one or more of the following: ending an audio stream; marking an audio stream according to one or more classifications; censoring one or more parts of the audio stream; and delaying the audio stream for a predetermined length of time.

According to various embodiments, the method further comprises continuing to convert each of the audio streams into a new text segment, wherein each new text segment corresponds to a new snippet of its corresponding audio stream, and, for each of the audio streams, saving each new text segment to the data store of real-time content and, when doing so, deleting one or more previously-saved text segments for the audio stream.

According to various embodiments, the method further comprises, after determining whether the one or more bid criteria have been met for the audio stream, determining, one or more new text segments, whether the one or more bid criteria are still met for the audio stream.

According to various embodiments, the method further comprises: determining whether each of the one or more advertising offers has been accepted or declines; when an advertising offer of the one or more advertising offers has been accepted, presenting the accepted advertising offer to one or more users accessing the audio stream; and, when an advertising offer of the one or more advertising offers has been declined, removing the declined advertising offer.

According to another aspect of the present disclosure, a system for real-time searching of audio streams to facilitate content moderation and advertising offer generation is provided. The system comprises a service comprising a processor, a receiver, a data store of real-time content, a client device, and programming instructions. The programming instructions, when executed, may cause the service to receive, using a digital media search and presentation service, a plurality of audio streams from a plurality of audio content sources, convert, using the digital media search and presentation service, each of the audio streams, in real-time, as the audio streams are received, into one or more text segments, wherein each text segment of the one or more text segments corresponds to a snippet of its corresponding audio stream and includes words spoken or sung in the snippet, save each text segment to a data store of real-time content, receive, using a programmatic graphical user interface of a real-time bidding system, one or more advertiser bids, wherein each of the one or more advertiser bids includes one or more bid criteria, determine, for at least one of the one or more advertiser bids, whether the one or more bid criteria are met for an audio stream of the plurality of audio streams, when the one or more bid criteria have been met for the at least one of the one or more advertiser bids, select one or more winning bids from advertiser bids in which the one or more bid criteria have been met, generate one or more advertising offers for each of the one or more winning bids, and present the one or more advertising offers to a representative of the audio stream.

According to various embodiments, the programming instructions configured to cause the processor to convert each of the audio streams further include programming instructions configured to cause to the processor to receive the audio stream, process the snippet of the audio stream with a speech-to-text converter, and save output from the speech-to-text converter to the real-time data store as the text segment.

According to various embodiments, the programming instructions configured to cause the processor to receive the plurality of audio streams from a plurality of audio content sources further include programming instructions configured to cause to the processor to receive one or more audio streams from a digital streaming source via a communication network, and receive one or more audio streams from an over-the-air broadcasting source.

According to various embodiments, the programming instructions are further configured to cause the processor to determine and assign, to each audio stream, at least one of: a rating; and a classification.

According to various embodiments, the programming instructions are further configured to cause the processor to perform one or more moderation tasks.

According to various embodiments, the one or more moderation tasks include one or more of the following: ending an audio stream; marking an audio stream according to one or more classifications; censoring one or more parts of the audio stream; and delaying the audio stream for a predetermined length of time.

According to various embodiments, the programming instructions are further configured to cause the processor to continue to convert each of the audio streams into a new text segment, wherein each new text segment corresponds to a new snippet of its corresponding audio stream, and for each of the audio streams, save each new text segment to the data store of real-time content and, when doing so, deleting one or more previously-saved text segments for the audio stream.

According to various embodiments, the programming instructions are further configured to cause the processor to determine whether each of the one or more advertising offers has been accepted or declines, when an advertising offer of the one or more advertising offers has been accepted, present the accepted advertising offer to one or more users accessing the audio stream, and, when an advertising offer of the one or more advertising offers has been declined, remove the declined advertising offer.

According to yet another aspect of the present disclosure, a digital media search and presentation service for real-time searching of audio streams to facilitate content moderation and advertising offer generation is provided. The digital media search and presentation service comprises a memory device communicatively, connected to a processor, containing programming instructions. The programming instructions, when executed by the processor, may cause the processor to receive a plurality of audio streams from a plurality of audio content sources, convert each of the audio streams, in real-time, as the audio streams are received, into one or more text segments, wherein each text segment of the one or more text segments corresponds to a snippet of its corresponding audio stream and includes words spoken or sung in the snippet, save each text segment to a data store of real-time content, receive, using a programmatic graphical user interface, one or more advertiser bids, wherein each of the one or more advertiser bids includes one or more bid criteria, determine, for at least one of the one or more advertiser bids, whether the one or more bid criteria are met for an audio stream of the plurality of audio streams, when the one or more bid criteria have been met for the at least one of the one or more advertiser bids, select one or more winning bids from advertiser bids in which the one or more bid criteria have been met, generate one or more advertising offers for each of the one or more winning bids, and present the one or more advertising offers to a representative of the audio stream.

### BRIEF DESCRIPTION OF THE DRAWINGS

FIG. 1 is a block diagram that shows various devices and systems that may interact with a live audio advertising bidding and moderation system.

FIG. 2 is a block diagram that shows various devices and systems that a live audio advertising bidding and moderation system may include.

FIG. 3 is a flow chart illustrative how a live audio advertising bidding and moderation system may operate, according to various embodiments of the present disclosure.

FIG. 4 describes example elements of an electronic device that may be used in various components of a digital audio stream search and presentation system.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” When used in this document, the term “exemplary” is intended to mean “by way of example” and is not intended to indicate that a particular exemplary item is preferred or required.

Other terms that are relevant to this disclosure will be defined at the end of this Detailed Description.

During live broadcasts (e.g., live radio, streaming, audio and/or video broadcasts), words are generally spoken, and the content of which (e.g., the topics discussed, the language/vocabulary used, the age-appropriateness of the discussions, etc.) can be consistent and/or can dynamically change during the broadcast. Utilizing a system which can transcribe these words, in real-time, and which can make these words searchable and or classifiable using one or more suitable means of identification and/or classification, better enables live broadcasts to be effective moderated and analyzed for the insertion of one or more advertisements.

For example, concerning the placement of advertisements, according to various embodiments of the present disclosure, spoken words may be transcribed, in real-time, and each spoken word that has been broadcast and transcribed may be made searchable for one or more advertisers. Once the spoken words have been identified and transcribed, one or more advertisers may bid on these identified and transcribed words, in real-time, to compete to insert audio and/or visual advertisements that listeners/viewers may hear, see, and/or interact with, in real-time, during the live broadcast. According to an exemplary embodiment, these advertisements may not rely on personal identifiable information (PII) but rather may rely on real-time activity of the listener/viewer (e.g., Person A is, right now, listening to a broadcast from Person B).

Concerning moderation of live broadcast content, spoken words may be identified and transcribed, in real-time, and each of the spoken words being broadcast may be made searchable for moderation purposes in order to identify and/or guard against undesired and/or monitored content (e.g., hate speech, profanity, mature content, etc.). According to various embodiments, the moderation may include a dynamic ratings system configured to dynamically generate, in real-time, a rating of the live broadcast based on the identified and transcribed spoken words within the live broadcast. This enables the system to better create safe spaces for listeners of all ages.

According to various embodiments, once a spoken word, and/or a plurality of spoken words, is identified, machine learning may be used to determine a context/classification of the words, a quality of the content of the spoken word(s), and/or other attributes of the spoken word(s), in order to provide, to one or more users, a preview of the content. According to various embodiments, the preview may include one or more audio and/or visual clues (e.g., audible sounds, color codings, ratings, etc.).

According to various embodiments of the present disclosure, ratings and/or context/classifications may be determined periodically over time and set or changing time intervals.

Due at least to the real-time applications of live broadcast analyses, the embodiments of the present disclosure provide users (e.g., listeners and/or potential advertisers) improved tools for content consumption and marketing, respectively.

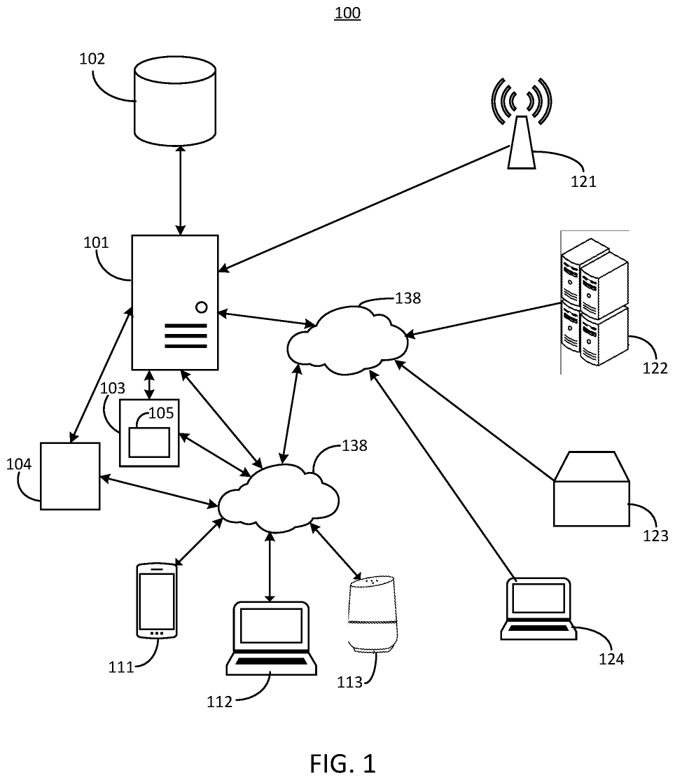

Referring now to FIG. 1, an overview of various elements that may be included in a live audio advertising bidding and moderation system 100 described in this document is illustratively depicted, in accordance with various embodiments of the present disclosure.

A digital media search and presentation service 101 may include communications hardware that is configured to enable the live audio advertising bidding and moderation system 100 to receive one or more audio and/or audiovisual streams from one or more audio and/or audiovisual content sources. For example, the digital media search and presentation service 101 may include one or more antennas and and/or receivers that are configured to receive one or more live broadcasts from over-the-air radio and/or television stations 121 and/or other suitable sources. In addition or alternatively, the digital media search and presentation service 101 also may include an Ethernet, Wi-Fi, and/or other suitable connection that is configured to connect the digital media search and presentation service 101 to one or more communication networks 138 via which it may receive one or more streams from one or more external content providers such as, e.g.: (i) one or more digital broadcasting services such as, e.g., satellite radio services, digital radio, and/or television channels 122; (ii) one or more Internet media delivery services such as, e.g., one or more streaming music and/or video services, social media services, and/or podcast services 123; and/or (iii) one or more individuals who are uploading digital audio and/or video streams to the Internet via one or more personal electronic devices 124.

According to various embodiments, the digital media search and presentation service also may be configured to receive and use one or more audio and/or audiovisual streams that originate from within the digital media search and presentation service 101 itself, and/or from one or more affiliates of the digital media search and presentation service 101. At least some of the digital audio and/or audiovisual streams may be live audio streams, although it is possible that some or all of the streams may be on-demand and/or pre-recorded streams. As used in this document, the terms “audio stream” and “audio content” may include transmissions that consist purely of audio content, as well as transmissions that include audio and other content such as an audio track with video and/or data tracks. At least some of the digital audio and/or audiovisual streams may include spoke word, music (e.g., songs, instrumental music, singing, etc.), and/or other suitable material.

The digital media search and presentation service 101 may include an Ethernet, Wi-Fi, and/or one or more other connections that are configured to connect the digital medial search and presentation service 101 to one or more communication networks 138 via which the digital media search and presentation service 101 may be configured to receive one or more requests from, and provide responses to, any number of client electronic devices. Each client device may include: one or more processors; one or more user interfaces; one or more speakers, audio ports, and/or near-field transmitters for audio output; and/or one or more communications hardware elements configured for communicating with the digital media search and presentation service 101 via the one or more communication networks 138. The client electronic devices may include, for example: smartphones 111; tablet, laptop and/or desktop computers 112; and/or one or more Internet-connected audio presentation devices such as, e.g., media players and digital home assistants 113. The client electronic devices may include one or more software applications configured to enable the client electronic device to send one or more requests to, and/or receive one or more responses from, the digital media search and presentation service 101. The client electronic devices may also include a browser and/or one or more other software applications that are configured to enable the client electronic device to receive one or more digital audio streams from audio content sources (such as, e.g., content sources 122 and 123) by pointing the browser and/or one or more other applications to an address at which the stream is hosted. Optionally, the client electronic devices may also include one or more antennas and/or include software configured to enable the client electronic device to receive over-the-air broadcasts from over-the-air broadcast sources 121.

The digital media search and presentation service 101 may include a processor, and it may include, or be communicatively connected to, a memory containing programming instructions that are configured to cause the digital media search and presentation service's 101 processor to perform some or all of the functions described in this document. The digital media search and presentation service 101 is not limited to a single processor and a single location. In various embodiments, the digital media search and presentation service 101 may be implemented by multiple geographically-distributed servers to help reduce communication latency between client devices and the digital media search and presentation service 101, regardless of client electronic device location.

According to various embodiments, the digital media search and presentation service 101 may include, or be connected to, a data store 102 configured to store information that is required to access and receive content from one or more digital audio sources, such as, e.g., application programming interfaces (APIs) for various audio services, uniform reference locators (URLs) or other digital coordinates at which digital audio sources make streams available, and/or frequencies of over-the-air broadcasters, among other suitable digital audio sources.

Notably, in the embodiments discussed in this document, the digital media search and presentation service 101 may not need to record or store recordings (such as digital audio files) of audio content that it receives from the one or more digital audio sources. However, the embodiments of the present disclosure may not necessarily be limited to such an embodiment, as it is contemplated that the digital media search and presentation service 101 may be configured to store content in one or more alternate embodiments.

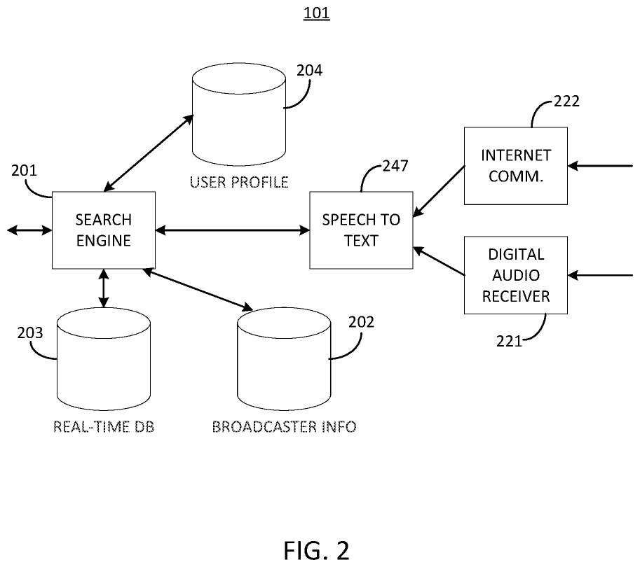

Referring now to FIG. 2, example components of the digital media search and presentation service 101 are illustratively depicted, in accordance with various embodiments of the present disclosure.

According to various embodiments, the core of the digital media search and presentation service 101 is a search engine 201 which includes one or more processors and programming instructions that are configured to cause the digital media search and presentation service 101 to analyze audio content segments, receive search requests, and/or identify segments (and the segments' associated sources) that are responsive to the requests. These features will be discussed in more detail below. The digital media search and presentation service 101 may include a digital audio receiver 221 and/or a communication network receiver 222, as were described in FIG. 1 above, as well as a speech-to-text engine 247 that includes one or more processors and programming instructions that are configured to instruct the speech-to-text engine 247 to receive audio streams from one or more selected audio sources, analyze the streams in real time as they are received, and convert the stream's content into text. The speech-to-text engine 247 may include one or more applications that receive streams from the remote sources, such as APIs, browsers, media players and/or other applications. The speech-to-text engine 247 may be configured to perform its speech-to-text conversion internally, or it may incorporate functions of now or hereafter available third party speech-to-text services such as, e.g., Google Cloud Speech-to-Text, Amazon Polly, Microsoft Azure and/or IBM's Watson, using an API or other mechanism to call the third party services. Alternatively, the third party content provider itself may provide the text segment for the service to use, in which case the service will not need to convert the segment to text format.

The digital media search and presentation service 101 may be configured to temporarily store the text segments generated by the speech-to-text engine 247 in a real-time data store 203 for use by the search engine 201. Each text segment may be a single word, or a group of words corresponding to a single (typically very short) time period, and/or other word grouping. Optionally, the live audio advertising bidding and moderation system 100 may be configured to store a sequential series of one or more text segments. If so, saving the text for each segment to the data store may include appending the newly-received text segment to the stored text and deleting an oldest portion of the stored text from the data store. Optionally, deleting the oldest portion may happen only if the new text segment's size has a size that exceeds a threshold, if the size of all text segments stored for the source exceeds a threshold, or if the oldest segment is older than a threshold age. As previously noted, while the live audio advertising bidding and moderation system 100 may be configured to temporarily store text segments, according to various embodiments, the live audio advertising bidding and moderation system 100 may not need to store any audio files and/or audio recordings of the streamed audio content.

As previously noted, the digital media search and presentation service 101 may also include a data store of content provider information 202 that it can use to receive audio content streams. The digital media search and presentation service 101 may also include a user profile data store 204 in which the system stores profile information for users (e.g., listeners and/or advertisers) of client devices, such as usernames and keys or other access credential verification mechanisms for users, historical usage data (such as previous search terms, and previous streams accessed), presets (i.e., saved searches and/or favorites), and/or other profile data.

According to various embodiments, the system 100 is configured to identify and transcribe, in real-time, one or more words of one or more live audio streams, and is configured to perform real-time tracking of the identified and transcribed spoken words for the purpose of affixing advertising, in real-time, through a real-time bidding system 103. The real-time bidding system 103 is configured to identify one or more phrases that have been predetermined by the advertiser.

The real-time bidding system 103 includes one or more processors and programming instructions that are configured to cause the real-time bidding system 103 to receive bid requests, analyze text, determine content ratings and/or classifications, generate advertising offers, and the present one or more advertisements. The real-time bidding system 103 may be in electronic communication with the digital media search and presentation service 101.

The one or more phrases may include individual words, individual sounds, and/or strings of multiple words and/or sounds, on which an advertiser can bid to display one or more advertisements upon the identification and transcription of the one or more phrases within the live audio stream. For example, an advertiser that supplies cleaning products and/or services may bid on phrases such as, e.g., strings of words, such as, e.g., “My in-laws are coming to town next week and I still haven't cleaned our home,” etc., and/or individual words, such as, e.g., “clean,” “cleans,” “cleaned,” etc.

According to various embodiments, the real-time bidding system 103 may include a programmatic graphical user interface 105 configured such that one or more advertisers may, via the programmatic graphical user interface 105, bid on one or more phrases and/or purchase one or more phrases for the purpose of advertising to one or more users who are listening to these words, in real-time, during the live audio stream. Bids may include maximum and/or minimum monetary amounts per advertisement. According to various embodiments, when space is available during a live audio stream, bid criteria for one or more advertisers, which is stored and includes personalized information concerning a bid, including information on the advertiser, the minimum and maximum of the bid, and/or any regulatory characteristics of the bid, is analyzed. The real-time bidding system 103 may be configured to characteristics (impressions) of the advertisement opening space (type of content, number of viewers/listeners, etc.) and compare the characteristics of the opening against the bid criteria in order to select the bid of one of the advertisers as the winning bid.

According to various embodiments, an advertiser may ‘own’ every utterance of a phrase and/or every utterance of a defined meaning behind a phrase (e.g., a defined meaning of the phrase “clean”) for a set length of time (e.g., a minute, an hour, a day, etc.) on a platform by purchasing the phrase using the programmatic graphical user interface 105 in order to produce, to a user, an advertisement, marketing products and/or services listeners, in real-time. The utterances may be spoken, sung, displayed (e.g., in text, images, etc.) and/or otherwise presented to one or more users.

According to various embodiments, when a phrase associated with an advertisement is identified within a live audio stream, the real-time bidding system 103 may be configured to automatically generate one or more advertising offers, wherein each advertising offer includes an offer to incorporate one or more advertisements in conjunction with the live audio stream. The advertising offers may include one or more fee arrangements for the use of the one or more advertisements during the live audio stream.

According to various embodiments, the real-time bidding system 103 may be configured to enable advertisers to select a viewership limit. For example, the advertisers may select, using the programmatic graphical user interface 105, that advertising offers only be sent to users (e.g., listeners, viewers, etc.) when a number of users of the live audio stream meets and/or exceeds a predetermined amount. For example, an advertiser may select indicate, using the programmatic graphical user interface 105, that, when a phrase is identified, only send an advertising offer if the number of viewers or listeners is greater than 50, 100, and/or other suitable numbers of viewers or listeners.

According to various embodiments, the real-time bidding system 103 is configured to send the one or more advertising offers to a representative of the live audio stream (e.g., a producer of the live audio stream, a presenter of the live audio stream, and/or other suitable representative). According to various embodiments, the system is configured to enable the representative to accept or decline such advertising offers. According to various embodiments, during the live audio stream, the representative may be presented with a visual and/or audio prompt, indicating the advertising offer. According to various embodiments, the advertising offer is presented to the representative in a manner in which one or more listeners/viewers are not privy to the advertising offer. If the advertising offer is in an audio format, the advertising offer is presented to the representative in a manner in which the one or more listeners/viewers are not able to hear the advertising offer. If the advertising offer is in a visual format, the advertising offer is presented to the representative in a manner in which the one or more listeners/viewers are not able to see the advertising offer. According to various embodiments, the advertising offer may take the form of a combination of forms (e.g., both audible and visual forms).

For example, the advertising offer may include an audible prompt, such as: “Hi we're an insurance company and you just said one of our chosen keywords, ‘healthcare.’ Based on your 43 listeners, we're offering you $150 to play our 10-second add right now. Tap below to accept and rejoin your broadcast to listeners after our 10-second audio/video/text ad is displayed/plays.” The representative would then have the option to accept or decline and, if the advertising offer is accepted, funds would then be deposited into their account and the advertisement or advertisements indicated in the advertising offer presented to one or more users (e.g., listeners, viewers, etc.). Advertisements may be presented to users in audio format, in visual format, and/or other suitable forms of advertisement presentation. According to various embodiments, the advertisement may include one or more links which the user can select.

According to various embodiments, the system 100 may include a graphical user interface 125 coupled to a content creation and/or supplying device (e.g., device 124) for presenting the one or more advertising offers to the representative. According to various embodiments, the graphical user interface may be configured to display multiple advertising offers from which the representative is capable of accepting and/or denying.

Advertising offers may be time sensitive. For example, an advertiser may indicate that certain advertisements are time sensitive after utterance of one or more phrases. In these examples, the advertising offer may include a time limit for responding to the advertising offer. According to various embodiments, when the time limit expires, the advertising offer is removed or otherwise made incapable of accepting.

According to various embodiments, the system 100 is configured to perform real-time tracking of the identified and transcribed spoken words for the purpose of performing screening analytics in order to identify and/or guard against undesired and/or monitored content (e.g., hate speech, profanity, mature content, etc.).

According to various embodiments, the process of performing screening analytics includes is performed by a real-time moderation system 104. The real-time moderation system 104 includes one or more processors and programming instructions that are configured to cause the real-time moderation system 104 to perform one or more of the tasks described herein. The real-time moderation system 104 may be in electronic communication with the digital media search and presentation service 101 and/or the real-time bidding system 103.

The real-time moderation system 104 may be configured to analyze and mark content (e.g., entire live audio streams, sections of live audio streams, etc.) according to a dynamic ratings system. Marking content may include dynamically generating, in real-time, a rating of the live audio stream based on the identified and transcribed spoken words within the live audio stream. For example, content may be marked with an “M” for mature, a “T” for teenagers and up, an “A” for all audiences, and/or other suitable rating categories. Marking content may include color coding content. For example, content may be marked red for mature, yellow for teenagers and up, green for all audiences, and/or other suitable colors for these and/or other suitable rating categories. Other suitable marking types may be implemented while maintaining the spirit and functionality of the present disclosure. The markings are configured to indicate to one or more users (e.g. listeners, viewers, etc.) what content the one or more users may hear when the live audio stream is accessed.

According to various embodiments, the real-time bidding system 103 may configured to enable advertisers to restrict advertising offers to content marked as having one or more ratings under the dynamic ratings system. For example, the advertisers may select, using the programmatic graphical user interface 105, that their advertisements only be presented to users (e.g., listeners, viewers, etc.) of live audio streams when the live audio streams have a rating of all audiences. According to various embodiments, the real-time bidding system 103 may be configured to enable advertisers to have their advertisements removed from live audio streams due to a change in the rating of the live audio stream. The live audio advertising bidding and moderation system 104 may be configured to automatically determine a rating, and/or change thereof, of a live audio stream and/or automatically remove one or more advertisements based on a change in the rating of a live audio stream. According to various embodiments, the real-time bidding system 103 may be configured to generate and/or send one or more notifications to advertisers notifying advertisers of the content during which their one or more advertisements were presented.

According to various embodiments, the real-time moderation system 104 may be configured to analyze the identified and transcribed spoken words within a live audio stream in order to determine, in real-time, one or more classifications in which content of the live audio stream belongs. For example, speech analysis of a live audio stream may indicate that the content of the live audio stream belongs to classifications such as intellectual, educational, religious, spiritual, high quality content, low quality content, content suitable for n^{th} grade, hate speech, profanity, potentially inaccurate medical advice, gender-biased language, and/or other suitable classifications that may be useful to one or more users (e.g., listeners, viewers, etc.), and/or advertisers. According to various embodiments, the analysis is performed using machine learning.

According to various embodiments, the real-time bidding system 103 may configured to enable advertisers to restrict advertising offers to content marked as having one or more classifications and/or to remove their advertisements from content marked as having one or more classifications. For example, the advertisers may select, using the programmatic graphical user interface 105, that their advertisements only be presented to users (e.g., listeners, viewers, etc.) of live audio streams when the live audio streams have one or more particular content classifications. According to another example, the advertisers may select, using the programmatic graphical user interface 105, that their advertisements not be presented to users (e.g., listeners, viewers, etc.) of live audio streams when the live audio streams have one or more particular content classifications. According to various embodiments, the real-time bidding system 103 may be configured to enable advertisers to have their advertisements removed from live audio streams due to a change in the classification of the live audio stream. The moderation system 104 may be configured to automatically determine a classification, and/or change thereof, of a live audio stream and/or automatically remove one or more advertisements based on a change in the classification of a live audio stream. According to various embodiments, the moderation system 104 may be configured to generate and/or send one or more notifications to advertisers notifying advertisers of the content during which their one or more advertisements were presented. According to various embodiments, advertiser bids may be based on phrases and/or classifications.

According to some embodiments, the representatives are aware of one or more bids prior to bid-satisfying criteria (e.g., phrases, classifications, etc.) being met. According to some embodiments, the representatives are not aware of one or more bids prior to bid-satisfying criteria being met.

According to various embodiments, the real-time bidding system 103 and/or the real-time moderation system 104, may be integrated into the digital media search and presentation service 101 and/or may be one or more separate systems.

According to various embodiments, real-time moderation system 104 may be configured to perform one or more moderation tasks based on the classification of content of a live audio stream. The one or more moderation tasks may include, e.g., ending and/or pulling a live audio stream, marking a live audio stream based on one or more classifications (e.g., marking a live audio stream as including hate speech, profanity, potentially inaccurate medical advice, gender-biased language, etc.), delaying the audio stream (e.g., adding a delay (e.g., a 15 second delay and/or other suitable delay and/or predetermined length of time)) to a live audio stream, censoring one or more parts of an audio stream (e.g., censoring speech classified as profanity), and/or other suitable moderation tasks.

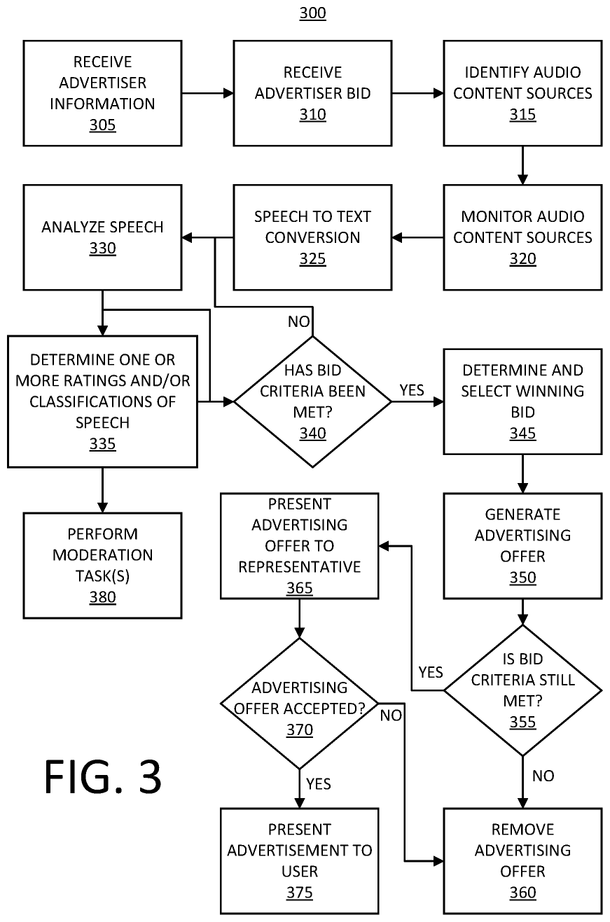

FIG. 3 is a flow diagram illustrating a method 300 of how a live audio advertising bidding and moderation system may operate, according to various embodiments of the present disclosure.

At 305, information from one or more advertisers is received into the system. According to various embodiments, the information may include, for each advertiser, information pertaining to the identity of the advertiser, a bid history, bid criteria history, and/or other suitable information. The information may be stored in a memory. At 310, one or more bids are receiving into the system using, e.g., the programmatic user interface of a real-time bidding system.

According to various embodiments, the bids may include one or more phrases that have been predetermined by the advertiser. The one or more phrases may include individual words, individual sounds, and/or strings of multiple words and/or sounds, on which an advertiser can bid to display one or more advertisements upon the identification and transcription of the one or more phrases within the live audio stream.

According to various embodiments, bids may include bid criteria. For example, the bids may be associated with one or more predetermined phrases, content ratings, and/or content classifications, and may include maximum and/or minimum monetary amounts per advertisement. According to various embodiments, the bid criteria may include criteria in which the bids and/or advertising offers are to be removed. For example, the bid criteria may indicate that advertising offers are to be removed in the event that the content of the live audio stream includes certain words or phrases and/or includes content having one or more ratings and/or classifications.

According to various embodiments, the bid criteria includes viewership criteria, and the real-time bidding system may be configured to enable advertisers to select a viewership limit. For example, the advertisers may select, using the programmatic graphical user interface, that advertising offers only be sent to users (e.g., listeners, viewers, etc.) when a number of users of the live audio stream meets and/or exceeds a predetermined amount. For example, an advertiser may select indicate, using the programmatic graphical user interface, that, when a phrase is identified, only send an advertising offer if the number of viewers or listeners is greater than 50, 100, and/or other suitable numbers of viewers or listeners.

The service may identify any number of audio content sources, at 315, and it may monitor audio streams from the identified sources, 320. The identification of audio content sources may be done before and/or after receiving bids, at 310. According to various embodiments, the system may monitor each audio and/or audiovisual stream, at 320, to receive content from each audio and/or audiovisual stream as it is transmitted by the audio and/or audiovisual stream's source.

For each of the audio and/or audiovisual streams, when monitoring the stream, the system may be configured, at 325, to use a speech-to-text converter to capture a sequence of speech-to-text segments of the audio and/or audiovisual stream. Each text segment may be a time-limited segment in that it may correspond to a limited duration snippet of the audio and/or audiovisual stream, such as 1 second, 5 seconds, 30 seconds, 1 minute, 3 minutes, 5 minutes, and/or other suitable time periods. The system may be configured to process one or more snippets of audio in the sequence in real time as the audio is received, to identify the words spoken or sung in each snippet to text to yield a text segment. The system may not need to store any audio segment that it receives. However, the system may store the resulting text segment in a data store for a limited time period, such as a time period equal to the duration of the segment. The system may be configured to store, in the data store as metadata or otherwise in association with the text segment, identifying information about the source of the text segment.

At 330, the identified and transcribed text is analyzed. According to various embodiments, the analysis, at 330, is performed in order to determine one or more phrases within the text. Based on the one or more phrases, it is determined, at 340, whether the bid criteria of the one or more bids has been met. According to various embodiments, as the text is being analyzed, one or more ratings and/or classifications of speech, at 335, are determined and assigned to the audio stream.

According to various embodiments, the system may include a real-time moderation system configured to, at 380, perform one or more moderation tasks based on the determined one or more ratings and/or classifications of speech.

According to various embodiments, the system is configured to perform real-time tracking of the identified and transcribed spoken words for the purpose of performing screening analytics in order to identify and/or guard against undesired and/or monitored content (e.g., hate speech, profanity, mature content, etc.).

According to various embodiments, the process of performing screening analytics includes is performed by the real-time moderation system. The real-time moderation system is configured to analyze and mark content (e.g., entire live audio streams, sections of live audio streams, etc.) according to a dynamic ratings system. Marking content may include dynamically generating, in real-time, a rating of the live audio stream based on the identified and transcribed spoken words within the live audio stream. For example, content may be marked with an “M” for mature, a “T” for teenagers and up, an “A” for all audiences, and/or other suitable rating categories. Marking content may include color coding content. For example, content may be marked red for mature, yellow for teenagers and up, green for all audiences, and/or other suitable colors for these and/or other suitable rating categories. Other suitable marking types may be implemented while maintaining the spirit and functionality of the present disclosure. The markings are configured to indicate to one or more users (e.g. listeners, viewers, etc.) what content the one or more users may hear when the live audio stream is accessed.

According to various embodiments, the real-time moderation system is configured to analyze the identified and transcribed spoken words within a live audio stream in order to determine, in real-time, one or more classifications in which content of the live audio stream belongs. For example, speech analysis of a live audio stream may indicate that the content of the live audio stream belongs to classifications such as intellectual, educational, religious, spiritual, high quality content, low quality content, content suitable for nth grade, hate speech, profanity, potentially inaccurate medical advice, gender-biased language, and/or other suitable classifications that may be useful to one or more users (e.g., listeners, viewers, etc.), and/or advertisers. According to various embodiments, the analysis is performed using machine learning.

According to various embodiments, at 380, the one or more moderation tasks may be based on the rating and/or classification of content of a live audio stream. The one or more moderation tasks may include, e.g., ending and/or pulling a live audio stream, marking a live audio stream based on the classification (e.g., marking a live audio stream as including hate speech, profanity, potentially inaccurate medical advice, gender-biased language, etc.), adding a delay (e.g., a 15 second delay and/or other suitable delay) to a live audio stream, censoring speech classified as profanity, and/or other suitable moderation tasks.

Based on these one or more ratings, one or more classifications of speech, and/or one or more phrases, it is determined, at 340, whether the bid criteria of the one or more bids has been met. For example, according to various embodiments, when space is available during a live audio stream, bid criteria for one or more advertisers, which is stored and includes personalized information concerning a bid, including information on the advertiser, the minimum and maximum of the bid, and/or any regulatory characteristics of the bid, is analyzed. The real-time bidding system may be configured to characteristics (impressions) of the advertisement opening space (type of content, number of viewers/listeners, etc.) and compare the characteristics of the opening against the bid criteria in order to select the bid of one of the advertisers as the winning bid.

If the bid criteria has not been met, than the speech is then analyzed, at 330. If the bid criteria has been met, then, at 345, one or more winnings bids are determined and, based on those one or more winning bids, one or more advertising offers, at 350, are generated for presenting to one or more content representatives. According to various embodiments, each advertising offer includes an offer to incorporate one or more advertisements in conjunction with the live audio stream. The advertising offers may include one or more fee arrangements for the use of the one or more advertisements during the live audio stream.

According to various embodiments, the text of the live audio stream is continuously identified, transcribed, and analyzed and, at any time after determining that the bid criteria has been met, the live audio stream can, at 355, be analyzed to determine whether the bid criteria is still met, due to the dynamic nature of live audio streams. According to various embodiments, if the bid criteria is not still met, then, at 360, the advertising offer is removed. According to various embodiments, if it is determined that the bid criteria is still met, then, at 365, the one or more advertising offers are presented/sent to the content representative.

According to various embodiments, the system is configured to send the one or more advertising offers to a representative of the live audio stream (e.g., a producer of the live audio stream, a presenter of the live audio stream, and/or other suitable representative). According to various embodiments, the system is configured to enable the representative to approve or decline such advertising offers. According to various embodiments, during the live audio stream, the representative may be presented with a visual and/or audio prompt, indicating the advertising offer. According to various embodiments, the advertising offer is presented to the representative in a manner in which one or more listeners/viewers are not privy to the advertising offer. If the advertising offer is in an audio format, the advertising offer is presented to the representative in a manner in which the one or more listeners/viewers are not able to hear the advertising offer. If the advertising offer is in a visual format, the advertising offer is presented to the representative in a manner in which the one or more listeners/viewers are not able to see the advertising offer. According to various embodiments, the advertising offer may take the form of a combination of forms (e.g., both audible and visual forms).

Advertisements may be presented to users in audio format, in visual format, and/or other suitable forms of advertisement presentation. According to various embodiments, the advertisement may include one or more links which the user can select.

According to various embodiments, the system may include a graphical user interface for presenting the one or more advertising offers to the representative. According to various embodiments, the graphical user interface may be configured to display multiple advertising offers from which the representative is capable of accepting and/or denying.

Once the one or more advertising offers are presented to the content representative, it is determined, at 370, whether one or more of the one or more advertising offers has been accepted or denied. If an advertising offer is not accepted, then, at 360, the advertising offer is removed. If an advertising offer is accepted, then, at 375, one or more advertisements associated with the accepted advertising offer are presented to one or more users.

Advertising offers may be time sensitive. For example, an advertiser may indicate that certain advertisements are time sensitive after utterance of one or more phrases that match bid criteria. In these examples, the advertising offer may include a time limit for responding to the advertising offer. According to various embodiments, when the time limit expires, the advertising offer, at 360, may be removed or otherwise made incapable of accepting.

Advertising offers may be presented to one or more users using one or more suitable, desirable, and/or selected means. For example, an advertisement may be presented using visual means, audible means, a combination or visual and/or audible means (e.g., video with sound), and/or through one or more other suitable means. According to various embodiments, the timing of the advertisement presentation may be affected by and/or dependent upon the type of media being presented. For example, if a live stream includes one or more songs that include an utterance matching the bid criteria, the advertisement may be presented between songs (e.g., before a next song plays). It is noted, however, that other advertisement presentation timing schemes may be implemented while maintaining the spirit and functionality of the present disclosure.

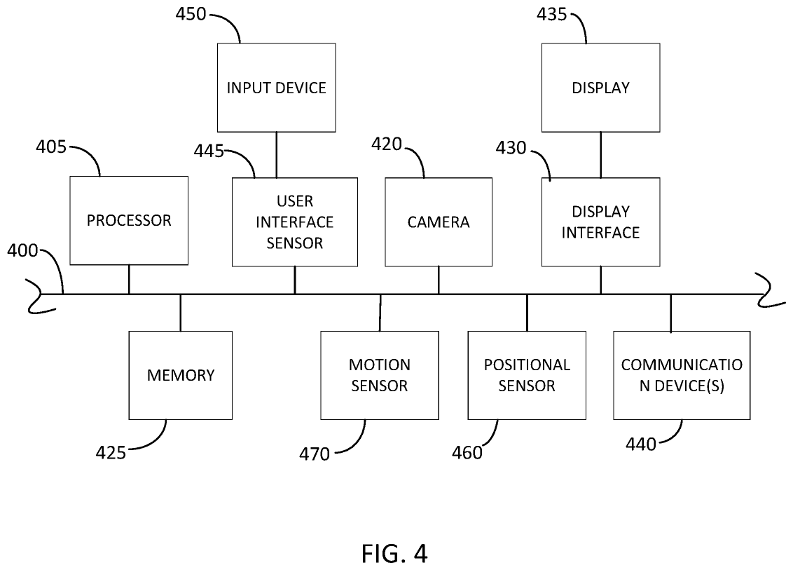

FIG. 4 depicts an example of internal hardware that may be included in any of the electronic components of the system, such as a user's client device, the server that provides the service, or a local or remote computing device in the system. An electrical bus 400 serves as an information highway interconnecting the other illustrated components of the hardware. Processor 405 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 425. A memory device may include a single device or a collection of devices across which data and/or instructions are stored.

An optional display interface 430 may permit information from the bus 400 to be displayed on a display device 435 in visual, graphic or alphanumeric format. An audio interface and audio output (such as a speaker) also may be provided. Communication with external devices may occur using various communication devices 440 such as a wireless antenna, an RFID tag and/or short-range or near-field communication transceiver, each of which may optionally communicatively connect with other components of the device via one or more communication system. The communication device 440 may be configured to be communicatively connected to a communications network, such as the Internet, a local area network or a cellular telephone data network.

The hardware may also include a user interface sensor 445 that allows for receipt of data from input devices 450 such as a keyboard, a mouse, a joystick, a touchscreen, a touch pad, a remote control, a pointing device and/or microphone. Digital image frames also may be received from a camera 420 that can capture video and/or still images. The system also may include a positional sensor 460 and/or motion sensor 470 to detect position and movement of the device. Examples of positional sensors 480 include a global positioning system (GPS) sensor device that receives positional data from an external GPS network.

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants, radios, devices equipped with digital audio capture (DAC) cards such as recording equipment and microphone-equipped devices, audio and/or video encoders, and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion below, a client device, server device, virtual machine or container may be referred to simply as a “device” for brevity. Additional elements that may be included in electronic devices were discussed above in the context of FIG. 4.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

As used in this document, the terms “digital media service,” “streaming media service,” “broadcast service” and related or similar terms refer to systems, including transmission hardware and one or more non-transitory data storage media, that are configured to transmit digital content to one or more users of the service over a communications network such as the Internet, a wireless data network such as a cellular network or a broadband wireless network, a digital television broadcast channel or a cable television service in digital streaming format for real-time consumption by receiving electronic devices. Digital content streamed by such services will, at a minimum, include an audio component. Optionally, the digital content also may include a video component and/or metadata such as closed-captions, radio data system (RDS) data, and other data components such as those included in the ATSC 3.0 broadcast transmission standard. This document may use the term “digital audio stream” to refer to any digital content that is transmitted for consumption by subscribers and/or the public, and that includes at least an audio component.

The features and functions described above, as well as alternatives, may be combined into many other different systems or applications. Various alternatives, modifications, variations or improvements may be made by those skilled in the art, each of which is also intended to be encompassed by the disclosed embodiments.

1. A method of providing real-time searching of audio streams to facilitate content moderation and advertising offer generation, comprising:
receiving, using a digital media search and presentation service, a plurality of audio streams from a plurality of audio content sources;
converting, using the digital media search and presentation service, each of the audio streams, in real-time, as the audio streams are received, into one or more text segments, wherein each text segment of the one or more text segments corresponds to a snippet of its corresponding audio stream and includes words spoken or sung in the snippet;
saving each text segment to a data store of real-time content;
receiving, using a programmatic graphical user interface of a real-time bidding system, one or more advertiser bids, wherein each of the one or more advertiser bids includes one or more bid criteria;
determining, using a processor, for at least one of the one or more advertiser bids, whether the one or more bid criteria are met for an audio stream of the plurality of audio streams;
when the one or more bid criteria have been met for the at least one of the one or more advertiser bids, selecting, using the processor, one or more winning bids from advertiser bids in which the one or more bid criteria have been met;
generating, using the processor, one or more advertising offers for each of the one or more winning bids; and
presenting, using the processor, the one or more advertising offers to a representative of the audio stream.

2. The method of claim 1, wherein the converting each of the audio streams comprises:
receiving the audio stream;
processing the snippet of the audio stream with a speech-to-text converter; and
saving output from the speech-to-text converter as the text segment.

3. The method of claim 1, wherein receiving the plurality of audio streams from a plurality of audio content sources comprises:
receiving one or more audio streams from a digital streaming source via a communication network; and
receiving one or more audio streams from an over-the-air broadcasting source.

4. The method of claim 1, wherein:
the one or more bid criteria includes an utterance one or more phrases within the audio stream, and
each of the one or more phrases includes one or more predetermined words or sounds.

5. The method of claim 1, further comprising, using a real-time moderation system including a processor, determining and assigning, to each audio stream, at least one of: a rating; and a classification.

6. The method of claim 5, wherein the bid criteria includes a presence or absence of one or more of: one or more ratings of the audio stream; and one or more classifications of the audio stream.

7. The method of claim 5, further comprising performing, using the real-time moderation system, one or more moderation tasks.

8. The method of claim 7, wherein the one or more moderation tasks include one or more of the following:
ending an audio stream;
marking an audio stream according to one or more classifications;
censoring one or more parts of the audio stream; and
delaying the audio stream for a predetermined length of time.

9. The method of claim 1, further comprising:
continuing to convert each of the audio streams into a new text segment, wherein each new text segment corresponds to a new snippet of its corresponding audio stream; and
for each of the audio streams, saving each new text segment to the data store of real-time content and, when doing so, deleting one or more previously-saved text segments for the audio stream.

10. The method of claim 9, further comprising:
after determining whether the one or more bid criteria have been met for the audio stream, determining, one or more new text segments, whether the one or more bid criteria are still met for the audio stream.

11. The method of claim 1, further comprising:
determining whether each of the one or more advertising offers has been accepted or declines;
when an advertising offer of the one or more advertising offers has been accepted, presenting an accepted advertising offer to one or more users accessing the audio stream; and
when an advertising offer of the one or more advertising offers has been declined, removing a declined advertising offer.

12. A system for real-time searching of audio streams to facilitate content moderation and advertising offer generation, comprising:
a service comprising a processor, a receiver, a data store of real-time content, a client device, and programming instructions that, when executed, will cause the service to:
receive, using a digital media search and presentation service, a plurality of audio streams from a plurality of audio content sources;
convert, using the digital media search and presentation service, each of the audio streams, in real-time, as the audio streams are received, into one or more text segments, wherein each text segment of the one or more text segments corresponds to a snippet of its corresponding audio stream and includes words spoken or sung in the snippet;
save each text segment to a data store of real-time content;
receive, using a programmatic graphical user interface of a real-time bidding system, one or more advertiser bids, wherein each of the one or more advertiser bids includes one or more bid criteria;
determine, for at least one of the one or more advertiser bids, whether the one or more bid criteria are met for an audio stream of the plurality of audio streams;
when the one or more bid criteria have been met for the at least one of the one or more advertiser bids, select one or more winning bids from advertiser bids in which the one or more bid criteria have been met;
generate one or more advertising offers for each of the one or more winning bids; and
present the one or more advertising offers to a representative of the audio stream.

13. The system of claim 12, wherein the programming instructions configured to cause the processor to convert each of the audio streams further include programming instructions configured to cause to the processor to:
receive the audio stream;
process the snippet of the audio stream with a speech-to-text converter; and
save output from the speech-to-text converter to the data store as the text segment.

14. The system of claim 12, wherein the programming instructions configured to cause the processor to receive the plurality of audio streams from a plurality of audio content sources further include programming instructions configured to cause to the processor to:
receive one or more audio streams from a digital streaming source via a communication network; and
receive one or more audio streams from an over-the-air broadcasting source.

15. The system of claim 12, wherein the programming instructions are further configured to cause the processor to:
determine and assign, to each audio stream, at least one of: a rating; and a classification.

16. The system of claim 15, wherein the programming instructions are further configured to cause the processor to:
perform one or more moderation tasks.

17. The system of claim 16, wherein the one or more moderation tasks include one or more of the following:
ending an audio stream;
marking an audio stream according to one or more classifications;
censoring one or more parts of the audio stream; and
delaying the audio stream for a predetermined length of time.

18. The system of claim 12, wherein the programming instructions are further configured to cause the processor to:
continue to convert each of the audio streams into a new text segment, wherein each new text segment corresponds to a new snippet of its corresponding audio stream; and
for each of the audio streams, save each new text segment to the data store of real-time content and, when doing so, deleting one or more previously-saved text segments for the audio stream.

19. The system of claim 12, wherein the programming instructions are further configured to cause the processor to:
determine whether each of the one or more advertising offers has been accepted or declines;
when an advertising offer of the one or more advertising offers has been accepted, present the accepted advertising offer to one or more users accessing the audio stream; and
when an advertising offer of the one or more advertising offers has been declined, remove the declined advertising offer.

20. A digital media search and presentation service for real-time searching of audio streams to facilitate content moderation and advertising offer generation, the digital media search and presentation service comprising:
a memory device communicatively, connected to a processor, containing programming instructions that, when executed by the processor, will cause the processor to:
receive a plurality of audio streams from a plurality of audio content sources;
convert each of the audio streams, in real-time, as the audio streams are received, into one or more text segments, wherein each text segment of the one or more text segments corresponds to a snippet of its corresponding audio stream and includes words spoken or sung in the snippet;
save each text segment to a data store of real-time content;
receive, using a programmatic graphical user interface, one or more advertiser bids, wherein each of the one or more advertiser bids includes one or more bid criteria;
determine, for at least one of the one or more advertiser bids, whether the one or more bid criteria are met for an audio stream of the plurality of audio streams;
when the one or more bid criteria have been met for the at least one of the one or more advertiser bids, select one or more winning bids from advertiser bids in which the one or more bid criteria have been met;
generate one or more advertising offers for each of the one or more winning bids; and
present the one or more advertising offers to a representative of the audio stream.
